(19) United States
(12) Patent Application Publication
(10) Pub. No.: US 2010/0089333 A1
(43) Pub. Date: Apr. 15, 2010

(54) METHODS AND CAGES FOR SCREENING FOR INFECTIOUS AGENT IN LABORATORY ANIMALS

(76) Inventor: Robert Stevenson, South Autralia (AU)

Correspondence Address: BROOKS, CAMERON & HUEBSCH , PLLC, 1221 NICOLLET AVENUE , SUITE 500, MINNEAPOLIS, MN, 55403, US

(21) Appl. No.: 12/449,594

(22) PCT Filed: Feb. 15, 2008
(86) PCT No.: PCT/AU2008/000189

§ 371 Date: Dec. 2, 2009

Related U.S. Application Data
(60) Provisional application No. 60/889,991, filed on Feb. 15, 2007.

(30) Foreign Application Priority Data
Feb. 15, 2007 (AU) AU2007900832

(51) Int. Cl. A01K 1/03

(52) U.S. Cl. 119/418

(57) ABSTRACT

The present invention relates to a method of determining the presence of an infectious agent in one or more test animals. The method includes providing a cage housing a sentinel animal, the cage including a plurality of inlets to allow flow of air into the cage through each of the inlets; providing a plurality of cages each housing a test animal, each cage including an outlet to allow air to flow from the cage; connecting the plurality of cages each housing a test animal to the cage housing a sentinel animal so as to allow air to flow via the outlet of each cage housing a test animal into the cage housing a sentinel animal via an inlet on the cage housing a sentinel animal; and screening the sentinel animal for infection by the infectious agent after a period of time sufficient for the sentinel animal to be infected from one of the test animals, wherein infection of the sentinel animal is indicative of the presence of the infectious agent in one or more of the test animals.

This application claims priority from both Australian provisional patent application No. 2007900832 filed on 15 Feb. 2007 and U.S. provisional patent application 60/889,991 filed on 15 Feb. 2007, the contents of which are to be taken as incorporated herein by this reference.

### FIELD OF THE INVENTION

The present invention relates to a method of determining the presence of an infectious agent in laboratory animals.

The present invention also relates to a cage for housing a laboratory animal, and an assembly of such cages.

### BACKGROUND OF THE INVENTION

The demand for laboratory animals as research tools has grown enormously. To respond to this demand, laboratory animals are now generally maintained in facilities housing large numbers of the animals.

However, an on-going problem with such facilities is the uncertainty regarding the health and immunological status of animals in the population. Not only is the health of the laboratory animals important in its own right, but in many cases there is also a need for the animals to be of a consistent immunological and microbiological status for meaningful experimental results to be achieved.

Although laboratory animals are generally maintained in separate cages, there remains a significant risk of spread of infectious agents through the animal population, even when the animals are house in bio-contained cages. Such problems are exacerbated by the continual introduction of new animals of unknown health and immunological status into the facility at various times, and the use of animals with varying immunological responses in research.

Accordingly, monitoring of the microbiological status of the animals in the population is required to ensure the health of the animals, to prevent the spread of infectious agents in the population, and to ensure that the animals provide acceptable experimental subjects for research purposes.

A census approach for determining the health status of every animal in the population is generally undesirable and impractical. Although random sampling of individual animals in the colony may be undertaken, sampling of the animals in the population to a statistically significant level is often not feasible due to cost.

Contact sentinel animals may be used to determine the health status of animals in the population, but in this case a large number of sentinel animals is required to obtain a significant level of sampling. Once again, this approach is impractical and expensive.

The present invention relates to a method of determining the presence of an infectious agent in laboratory animals by using a sentinel animal housed in a cage which can be contacted with multiple cages housing laboratory animals from the population.

A reference herein to a patent document or other matter which is given as prior art is not to be taken as an admission that that document or matter was known or that the information it contains was part of the common general knowledge as at the priority date of any of the claims.

### SUMMARY OF THE INVENTION

The present invention arises from the recognition that in a facility housing a population of animals in cages for which it is necessary to determine the presence of infectious agents, the facility may be considered as a population of cages and not a population of animals. Each cage may be considered as one element of the population, and all animals within an individual cage may be considered as being of the same infectious status.

The present invention relates to a cage housing a sentinel animal which has the ability to dock with multiple contact cages containing animals from the population to be screened, providing a “quasi-contact” system between the sentinel animal and the other animals in the population. The infectious status of animals in the population can then be determined by determining the infectious status of the sentinel animal.

Accordingly, the present invention provides a method of determining the presence of an infectious agent in one or more test animals, the method including:
providing a cage housing a sentinel animal, the cage including a plurality of inlets to allow flow of air into the cage through each of the inlets;
providing a plurality of cages each housing a test animal, each cage including an outlet to allow air to flow from the cage;
connecting the plurality of cages each housing a test animal to the cage housing a sentinel animal so as to allow air to flow via the outlet of each cage housing a test animal into the cage housing a sentinel animal via an inlet on the cage housing a sentinel animal; and
screening the sentinel animal for infection by the infectious agent after a period of time sufficient for the sentinel animal to be infected from one of the test animals, wherein infection of the sentinel animal is indicative of the presence of the infectious agent in one or more of the test animals.

The present invention also provides an animal housing cage, the cage including a plurality of openings to allow air to flow into and/or out of the cage from each of the openings, and a plurality of connectors, each connector allowing direct or indirect connection of the animal housing cage to a second animal housing cage and (i) permitting air to flow into the second animal housing cage via an opening on the second animal housing cage from the animal housing cage via one of the plurality of openings and/or (ii) permitting air to flow out of the second animal housing cage via an opening on the second animal into the animal housing cage via one of the plurality of openings on the animal housing cage.

The present invention also provides an animal housing cage, the cage including a plurality of inlets to allow air to flow into the cage from each of the inlets and a plurality of connectors, each connector allowing direct or indirect connection of the animal housing cage to a second animal housing cage and permitting air to flow from the second animal housing cage via an outlet on the second animal housing cage into the animal housing cage via one of the plurality of inlets.

It has also been recognised that the above system of a cage with the ability to connect with multiple contact cages can be used to determine the susceptibility of test animals to infection with an infectious agent. In this case, the cage housing a sentinel animal is used to house an infected animal, and the ability of the infected animal to infect animals in the contact cages can be used to determine the susceptibility of those animals to infection.

The present invention therefore also provides a method of determining the susceptibility of one or more recipient animals to infection by an infectious agent, the method including:
providing a plurality of cages each housing a recipient animal, each cage including an inlet to allow air to flow into the cage;
providing a cage housing a host animal infected with an infectious agent, the cage including a plurality of outlets to allow flow of air from the cage through each of the outlets;
connecting the plurality of cages housing a recipient animal to the cage housing the host animal so as to allow air to flow via the outlet of the cage housing the host animal into each of the cages housing a recipient animal via an inlet on each of the cages housing a recipient animal; and
screening the recipient animals for infection by the infectious agent after a period of time sufficient for the recipient animals to be infected from the host animal, wherein infection of a recipient animal is indicative of the susceptibility of that recipient animal to infection by the infectious agent.

The present invention further provides an animal housing cage, the cage including a plurality of outlets to allow air to flow from the cage from each of the outlets and a plurality of connectors, each connector allowing direct or indirect connection of the animal housing cage to a second animal housing cage and permitting air to flow into the second animal housing cage via an inlet on the second animal housing cage from the animal housing cage via one of the plurality of outlets.

The present invention further provides an assembly of cages, the assembly including an animal housing cage including a plurality openings to allow air to flow into the animal housing cage from each of the openings and/or to allow air to flow from the animal housing cage from each of the openings, and a plurality of second animal housing cages, each second animal housing cage connected directly or indirectly to the animal housing cage, the connection between the animal housing cage and the second animal housing cage permitting air to flow from the second animal housing cage into the animal housing cage via an opening and/or permitting air to flow from the animal housing cage into the second animal housing cage via an opening.

The present invention also provides an assembly of cages, the assembly including an animal housing cage including a plurality of outlets to allow air to flow from the animal housing cage from each of the outlets, and a plurality of second animal housing cages, each second animal housing cage connected directly or indirectly to the animal housing cage, the connection between the animal housing cage and the second animal housing cage permitting air to flow from the animal housing cage into the animal housing cage via an outlet.

The present invention also provides an assembly of cages, the assembly including an animal housing cage including a plurality of inlets to allow air to flow into the animal housing cage from each of the inlets, and a plurality of second animal housing cages, each second animal housing cage connected directly or indirectly to the animal housing cage, the connection between the animal housing cage and the second animal housing cage permitting air to flow from the second animal housing cage into the animal housing cage via an inlet.

The present invention also provides an animal housing cage, the animal housing cage including a plurality of openings, each opening permitting a portion of a second animal housing cage to be received into the animal housing cage, wherein a substantially air tight seal is made between the animal housing cage and the second animal housing cage when the portion of the second animal housing cage is received into the animal housing cage.

### BRIEF DESCRIPTION OF THE FIGURES

The invention will now be described in further detail by reference to the attached figures illustrating embodiments of the invention. It is to be understood that the particularity of the drawings does not supersede the generality of the description of the invention.

In the Figures:

FIG. 1 shows an illustration of a sentinel cage according to one embodiment of the present invention.

FIG. 2 shows an illustration of a contact cage according to one embodiment of the present invention.

FIG. 3 shows an assembly of a sentinel cage docked with contact cages in one embodiment of the present invention.

FIG. 4 shows various views of a sentinel cage docked with a contact cage. Panel A shows a top view of the sentinel cage docked with a contact cage. Panel B shows a cross-sectional view of the sentinel cage docked with the contact cage shown in Panel A taken at the line A-A. Panel C shows an end view of the sentinel cage docked with a contact cage. Panel D shows a side view of the sentinel cage docked with a contact cage.

FIG. 5 shows a perspective view of a sentinel cage docked with a contact cage.

FIG. 6 shows an illustration of a sentinel cage according to an alternative embodiment of the present invention.

FIG. 7 shows an assembly of a sentinel cage and multiple contact cages in an alternative embodiment of the present invention, in which a portion of each of the contact cages has yet to be moved into the sentinel cage. Panel A shows a perspective view of the assembly. Panel B is a perspective view of the assembly showing the arrangement of selected internal components.

FIG. 8 shows a cut-away representation of FIG. 7B.

FIG. 9 shows an assembly of a sentinel cage and multiple contact cages in an alternative embodiment of the present invention, in which a portion of each of the contact cages has been inserted into the sentinel cage. Panel A shows a perspective view of the assembly. Panel B is a perspective view of the assembly showing the arrangement of selected internal components.

FIG. 10 shows a cut-away representation of FIG. 9B.

### GENERAL DESCRIPTION OF THE INVENTION

As described above, in one embodiment the present invention provides a method of determining the presence of an infectious agent in one or more laboratory animals using a sentinel animal housed in a cage (also referred to as “the sentinel cage”) that connects with multiple cages housing test laboratory animals (also referred to as “the contact cages”).

Accordingly, in one embodiment the present invention provides a method of determining the presence of an infectious agent in one or more test animals, the method including:
providing a cage housing a sentinel animal, the cage including a plurality of inlets to allow flow of air into the cage through each of the inlets;
providing a plurality of cages each housing a test animal, each cage including an outlet to allow air to flow from the cage;
connecting the plurality of cages each housing a test animal to the cage housing a sentinel animal so as to allow air to flow via the outlet of each cage housing a test animal into the cage housing a sentinel animal via an inlet on the cage housing a sentinel animal; and
screening the sentinel animal for infection by the infectious agent after a period of time sufficient for the sentinel animal to be infected from one of the test animals, wherein infection of the sentinel animal is indicative of the presence of the infectious agent in one or more of the test animals.

The test animal and the sentinel animal in the various embodiments of the present invention are generally the same type of animals (eg the same species), although it will be appreciated that the use of different animals, such as animals of a different species or genus, is also included within the scope of the present invention.

Suitable laboratory animals are known in the art. Examples of laboratory animals include rats, mice, guinea pigs, hamster, gerbils, ferrets, voles, rabbits, birds, non-human primates, dogs, cats, marsupials, and sheep.

As described above, the present invention may be used to determine the presence of an infectious agent in one or more test animals, by monitoring for the presence of the infectious agent in one or more of the sentinel animals. Examples of infectious agents include bacteria, viruses, fungi, parasites, and prions.

Depending upon the particular arrangement, the present invention provides for infection to occur by one or more routes, for example, by an airborne route, by an aerosol route and by a quasi-contact route.

Methods are known in the art for determining whether an animal has been infected with an infectious agent, including measuring an immunological response in the animal in response to infection by the infectious agent. Other methods for determining whether an animal has been infected with an infectious agent include microbiological culture methods, histological methods, PCR based methods and the infection of an animal on the basis of the features and symptoms displayed by the animal.

In this regard, the present invention includes screening one or more of the sentinel animals for infection by the infectious agent after a period of time sufficient for the sentinel animal to be infected from one of the test animals.

The period of time that the sentinel animal is maintained in infective contact with the test animals will depend upon the particular infectious agent of interest. In most cases, a period of time of 3 to 5 weeks is suitable to allow infection to occur, although it will be appreciated that periods of time shorter or longer than this time may be required. It will also be appreciated that more than one infectious cycle may be required to allow for transmission of the infectious agent in the various embodiments of the present invention.

In one embodiment, the sentinel animal is an immunocompetent animal.

In another embodiment, the sentinel animal is an immunocompromised or an immunodeficient animal. Examples of immunocompromised or immunodeficient animals include animals that have a genetic background responsible for the immune deficiency, or animals treated with a drug to induce immune deficiency, both of which are known in the art. An example of an immunodeficient mouse is a SCID mouse.

One or more sentinel animals may be used in the various embodiments of the present invention. In one specific embodiment, the cage housing the sentinel animal includes one or more immunocompetent animals and/or one or more immunocompromised animals.

The cages in the various embodiments of the present invention are generally cages of the biocontainment type, although it will be appreciated that types of cages are included within the scope of the present invention.

The sentinel cage in the various embodiment of the present invention includes a plurality of inlets, to allow flow of air into the cage through each of the inlets. The inlets act to allow flow of air into the sentinel cage from a contact cage upon connecting of the sentinel cage with a contact cage. As will be appreciated from the following discussion, it will be appreciated that in some embodiments the inlet may allow free passage of air through the inlet.

It will also be appreciated that in some embodiments, the inlet also acts as an aperture (opening) to receive part of a contact cage into the sentinel cage. In one specific embodiment, a substantially air tight seal is made when the contact cage is received into the sentinel cage. This may be achieved for example by a substantially air tight seal being made between the opening and the portion of the contact cage by use of a flexible ring surrounding the perimeter of the opening.

In one embodiment, the inlet is a single opening located in the wall of the cage. In another embodiment, a single inlet may be made up of multiple openings in the wall of the cage.

The size of each of the openings is not particularly limited, and generally will be of a size to allow movement of air from a contact cage into the sentinel cage. It will be appreciated that the size of the openings will influence the mode of transmission of the infectious agent. In the case where the opening is sufficiently large, or composed of openings of sufficient size, the openings will allow a quasi contact system to occur between animals, since the animals may be able to physically touch in this situation while still being maintained in separate cages. In cases where the openings are not of sufficient size for physical contact of the animals, it will be appreciated that the openings should still allow transmission of the infectious agent in the absence of physical contact, such as by the airborne or aerosol routes.

Each inlet on the sentinel cage may further include a grid or mesh covering the inlet. The grid or mesh may be incorporated into the wall of the sentinel cage, or be attached to the inner or outer wall of the sentinel cage. The size of the grid or mesh will generally be of a size to prevent escape of the animal from the cage, although smaller sizes may be used to prevent the exchange of material, such as bedding, into and/or out of the sentinel cage, as may occurs in a quasi-contact system.

As described above, it will also be appreciated that a similar result of preventing the exchange of material into and/or out of the sentinel cage may be accomplished without the use of a grid or mesh, by utilising an inlet composed of multiple small openings.

In another embodiment, the sentinel cage may further include a primary inlet to allow air to flow into the cage. This may be of use under circumstances when the sentinel cage is not connected to one of more other contact cages, and the inlets are closed to prevent flow of air into and/or out of the sentinel cage.

In another embodiment, the cage housing a sentinel animal may also include an outlet for allowing air to flow from the cage. The outlet may be a single aperture in a wall of the cage, or alternatively, the outlet may be composed of multiple openings in a wall of the cage.

In one embodiment, the cage housing the sentinel animal is under negative pressure applied at the outlet. This results in air being drawn into the sentinel cage, through the primary inlet and/or through each of the inlets for docking with the contact cages, if so connected. However, it will also be appreciated that the above system need not necessarily have the sentinel cage under negative pressure relative to the contact cages.

The plurality of cages each housing a test animal (“the contact cages”) are connected to the sentinel cage. In this regard, the term “connecting” is to be understood to mean that the sentinel cage and the contact cage are brought together in a manner, directly or indirectly, so as to allow transmission of an infectious agent. This will generally be by allowing at least air to flow from the contact cage into the sentinel cage via the openings on each of the cages.

As described in further detail below, in one embodiment the connecting of the cages involves a compatible coupling arrangement between cages.

However, it will also be appreciated that connection of the cages may involve the sentinel cage physically receiving a portion of a contact cage into the sentinel cage, or alternatively, a contact cage physically receiving a portion of the sentinel cage into the contact cage.

Generally, each of the contact cages may contain one or more test animals. Each of these animals may potentially be infected with an infectious agent that may then be transmitted to a sentinel animal.

Each contact cage includes an outlet to allow air to flow from the cage. In one specific embodiment the outlet may allow free passage of air between the contact cage and the sentinel cage.

The outlet may be a single aperture in the wall of the cage, or alternatively, the outlet may be composed of multiple openings in the wall of the cage. Each of the outlets acts to allow flow of air from the contact cage into the sentinel cage upon connection of the sentinel cage with a contact cage.

Once again, it will be appreciated that the size of each of the aperture or openings is not particularly limited, and generally will be of a size to allow movement of air from a contact cage into the sentinel cage. It will also be appreciated that the size of the openings will influence the mode of transmission of the infectious agent. In the case where the opening is sufficiently large, or composed of openings of sufficient size, the openings will allow a quasi contact system to occur between animals, since the animals may be able to physically touch in this situation while still being maintained in separate cages. In cases where the openings are not of sufficient size for physical contact of the animals, it will be appreciated that the openings should still allow transmission of the infectious agent, such as allowing airborne and/or aerosol transmission.

Each outlet on the contact cage may further include a grid or mesh covering the outlet. The grid or mesh may be incorporated into the wall of the contact cage, or be attached to the inner or outer wall of the contact cage. The size of the grid or mesh will generally be of a size to prevent escape of the animal from the cage, although smaller sizes may be used to prevent the exchange of material, such as bedding, into and/or out of the contact cage in a quasi-contact system.

It will also be appreciated that a similar result of preventing the exchange of material into and/or out of the contact cage may be accomplished without the use of a grid or mesh, by utilising an outlet composed of multiple small openings.

Each of the cages housing a test animal may further include an inlet to allow air to flow into the cage. The inlet may be a single aperture in a wall of the cage, or alternatively, the inlet may be composed of multiple openings in a wall of the cage. This inlet is typically necessary when the sentinel cage is placed under negative pressure with respect to the contact cages. Thus, in this fashion air is drawn through each of the contact cages into the sentinel cage.

The connection of the one or more cages housing a test animal to the cage housing a sentinel animal allows transmission of the infectious agent, generally by allowing air to flow via the outlet of each contact cage into the sentinel cage via an inlet.

In one embodiment, each contact cage is docked with the sentinel cage directly, thus making a direct connection between the cages.

In an alternative embodiment, one or more of the contact cages may be indirectly connected to the sentinel cage, for example by way of a spacer pipe or similar means between the cages.

As discussed previously herein, in another alternative embodiment either the sentinel cage or the contact cage may act to physically receive a portion of the other cage to provide a connection between the cages.

In this case, in one embodiment, the sentinel cage may include a material that allows a substantially air tight seal to be formed between the inlet on the sentinel cage and the portion of the contact cage received into the sentinel cage. For example, the inlet on the sentinel cage may have a rubber seal extending around all or part of the inlet, and under the circumstances where the contact cage is received into the sentinel cage, the seal engages with the contact cage (or a material thereon) to form a substantially air tight seal. It will also be appreciated that under the circumstances that a portion of the sentinel cage is received into the contact cage, then a similar configuration can occur on the outlet of the contact cage having a material that that allows a substantially air tight seal to be formed between the outlet on the contact cage and the portion of the sentinel cage received into the contact cage.

In another embodiment, the sentinel cage may include a sleeve that surrounds each inlet to guide and/or support the contact cage, the sleeve allowing a substantially air tight seal to be made when the contact cage is present in the sleave.

In another embodiment, the cage housing a sentinel animal and each of the cages housing a test animal include a compatible coupling arrangement to directly connect the cages together. This compatible coupling arrangement allows the docking of the sentinel cage and the contact cage together.

In one embodiment, the compatible coupling arrangement surrounds an inlet on the sentinel cage and surrounds the outlet on the contact cage.

In an alternative embodiment, the compatible coupling arrangement is located adjacent to the inlet and outlet on the sentinel and contact cage (respectively), and thus provides a means of bringing the inlet and outlet into contact, so as to transmission of an infection agent by allowing air flow from the contact cage into the sentinel cage without being located between the inlet and the outlet.

In the case of indirect connection of the cages together, a spacer pipe or similar means for conveying air may be used for example, each end of the spacer pipe having a coupling arrangement compatible for the cage to which it is to be docked.

In one embodiment, the coupling arrangement for direct or indirect connection provides a substantially air tight seal between the sentinel cage and the contact cage.

Examples of compatible coupling arrangements are known in the art, and include a mechanical clamp, magnetic clamps, or a male/female sleeve and O-ring arrangement, for example of the interference fit type.

In one embodiment, the sentinel cage includes the female component of a male/female sleeve and O-ring arrangement, and the contact cage includes the male component and O-ring. Thus, the contact cage is connected directly to the sentinel cage to allow air to flow between the cages.

In one embodiment, the cage housing the sentinel animal further includes a closure for each of the inlets to prevent air flow into the cage via an inlet under circumstances when air flow into the cage is not desired.

In one embodiment, each of the cages housing a test animal further includes a closure to prevent air flow from the cage via the outlet under circumstances when air flow out of the cage is not desired.

In another embodiment, each compatible coupling arrangement includes a closure that prevents air flow into the cage housing the sentinel animal via an inlet under circumstances when air flow into the sentinel cage is not desired.

The closure may be, for example, manually, mechanically or electrically operated, and be located, for example, vertically or horizontally with respect to the cages.

In another embodiment, each compatible coupling arrangement includes a closure that prevents air flow out of a cage housing a test animal via the outlet under circumstances when air flow out of the cage is not desired.

In another embodiment, the compatible coupling arrangement includes a closure on the sentinel side and a closure on the contact cage side.

In one specific embodiment, the different arrangements of closures described above are linked to each other so that the closures may be opened or closed together, if required. For example, a single handle attached to both closures can be used to simultaneously open and close the closures.

In the case where a portion of the one of the cages is physically received into another cage to allow a connection between the cages, in one embodiment a closure on either or both of the sentinel cage and the contact cage may be configured to allow opening of the closure upon receiving the end of the other cage, for example, by a means whereby the end of the cage being received physically contacts the closure and moves it from a closed position to an open position.

The cage housing the sentinel animal may further include a filter for each of the inlets, each filter filtering air flowing into the cage via an inlet. In one embodiment, the filter allows air to flow into the cage housing a sentinel animal but prevents infectious agents to escape from the cage. The primary inlet on the sentinel cage may also include a filter.

In one embodiment, the sentinel cage and the contact cages are not maintained under negative or positive pressure.

In another embodiment, the sentinel cage is maintained under negative pressure with respect to the contact cages, allowing air to flow into the sentinel cage from a contact cage. For example, a plenum may be attached to an exhaust outlet of the sentinel cage, thereby drawing air into the sentinel cage from a contact cage, when the cages are connected.

In another embodiment, the sentinel cage and one or more of the contact cages may contain an inlet for allowing animals in the cage to be euthanased, if and when required. A suitable inlet for this purposed is a gas inlet nipple.

It will also be appreciated that the system of a sentinel animal and potentially infected test animals in contact cages can be reversed, so as to allow infectious particles to be transferred from an animal held in a central cage (in this embodiment referred to as “a host animal”) to animals held in multiple contact cages (in this embodiment referred to as “a recipient animal”).

Such a method may be used to determine the susceptibility of one or more recipient animals to infection by an infectious agent. For example, such a method may be used to determine the susceptibility to infection of animals with certain genetic backgrounds.

Accordingly, in another embodiment the present invention provides a method of determining the susceptibility of one or more recipient animals to infection by an infectious agent, the method including:
providing a plurality of cages each housing a recipient animal, each cage including an inlet to allow air to flow into the cage;
providing a cage housing a host animal infected with an infectious agent, the cage including a plurality of outlets to allow flow of air from the cage through each of the outlets;
connecting the plurality of cages housing a recipient animal to the cage housing the host animal so as to allow air to flow via the outlet of the cage housing the host animal into each of the cages housing a recipient animal via an inlet on each of the cages housing a recipient animal; and
screening the recipient animals for infection by the infectious agent after a period of time sufficient for the recipient animals to be infected from the host animal, wherein infection of a recipient animal is indicative of the susceptibility of that recipient animal to infection by the infectious agent.

As discussed above, this embodiment of the present invention may be used to determine the ability of a recipient animal housed in a cage (also referred to as “a recipient cage”) to be infected with an infectious agent from a host animal housed in a cage (also referred to as “a host cage”). The presence of an infectious agent in a recipient animal indicates the susceptibility of that animal to infection. Examples of infectious agents are as previously discussed herein.

The recipient animal and the host animal are generally the same type of animal (eg the same species), although it will be appreciated that the use of different animals (eg a different species or genus) is also included within the scope of this embodiment of the present invention.

Examples of suitable laboratory animals are as previously discussed herein.

As described previously herein, methods are known in the art for determining whether a recipient animal has been infected with an infectious agent, including measuring an immunological response in the animal in response to infection by the infectious agent and PCR based methods. Other methods for determining whether an animal has been infected with an infectious agent include microbiological culture methods, histological methods, and the infection of an animal on the basis of the features and symptoms displayed by the animal.

In this regard, this embodiment of the present invention includes screening one or more of the recipient animals for infection by the infectious agent after a period of time sufficient for the recipient animal to be infected from a host animal.

As described previously herein, the period of time that the recipient animal is maintained in infective contact with the host animal will depend upon the particular infectious agent of interest. In most cases, a period of time of 3 to 5 weeks is suitable to allow infection to occur, although shorter or longer times may be required, and/or more than one infective cycle may be required.

In one embodiment, the recipient and/or host animal is an immunocompetent animal.

In another embodiment, the recipient and/or host animal is an immunocompromised or immunodeficient animal. Examples of immunocompromised or immunodeficient animals include animals that have a genetic background responsible for the immune deficiency, or animals treated with a drug to induce immune deficiency, both of which are known in the art.

One or more host animals may be used in this embodiment of the present invention. In one specific embodiment, the cage housing the host animal includes one or more immunocompetent animals and/or one or more immunocompromised animals.

It will be appreciated that the configuration and features of both a cage housing a recipient animal and a cage housing an infected animal are as previously described herein with reference to the embodiment involving a contact cage and sentinel cage, with the various features of the cage housing an infected animal having the features and configuration of a sentinel cage, and a cage housing a recipient animal having the features and configuration of a contact cage. Thus, it will be appreciated that the various embodiments as described previously herein in regard to a sentinel cage and contact cage, and the connection between, will generally apply to the cages in this embodiment.

The host cage in this embodiment of the present invention includes a plurality of outlets, to allow flow of air out of the cage through each of the outlets. The outlets act to allow transmission of an infectious agent, for example by flow of air from the host cage upon connection with a recipient cage. Once again, in one embodiment the outlet may also allow air into the cage through each of the outlets.

In one embodiment, the outlet is a single opening located in the wall of the cage. In another embodiment, the outlet is made up of multiple openings in the wall of the cage.

As generally described previously herein, the size of each of the openings is not particularly limited, and generally will be of a size to at least allow free movement of air from the host cage into a recipient cage through the outlet.

Each outlet on the host cage may further include a grid or mesh covering the outlet. The grid or mesh may be incorporated into the wall of the sentinel cage, or be attached to the inner or outer wall of the host cage. The size of the grid or mesh will generally be of a size to prevent escape of the animal from the cage, although smaller sizes may be used to prevent the exchange of material, such as bedding, into and/or out of the host cage.

It will also be appreciated that a similar result of preventing the exchange of material into and/or out of the host cage may be accomplished without the use of a grid or mesh, by utilising an outlet composed of multiple small openings, as previously described herein.

In one embodiment, the host cage further includes a primary inlet to allow air to flow into the cage.

In another embodiment, the cage housing the host animal also includes an outlet for allowing air to flow from the cage.

In one embodiment, the cage housing the host animal is under positive pressure applied at the primary inlet. This results in air being drawn from the host cage into each of the recipient cages.

In an alternative embodiment, the cage housing the recipient animal is under negative pressure applied at an outlet on the cage. This results in air being drawn into each of the recipient cages.

The plurality of cages each housing a recipient animal (“recipient cages”) are connected to the host cage. As described previously herein, the term “connecting” is to be understood to mean that the host cage and the recipient cage are brought together so as to allow transmission of an infectious agent, directly or indirectly, for example by allowing air to flow from the host cage into the recipient cage.

Various means of connecting the cages are as previously described herein.

Each of the recipient cages may contain one or more test animals.

Each contact cage includes an inlet, to allow air to flow into the cage. The inlet may be a single aperture in the wall of the cage, or alternatively, the inlet may be composed of multiple openings in the wall of the cage. Each of the inlets acts to at least allow flow of air from the host cage into the recipient cage upon docking of the host cage with a recipient cage.

Each inlet on the recipient cage may further include a grid or mesh covering the inlet. The grid or mesh may be incorporated into the wall of the cage, or be attached to the inner or outer wall of the cage. The size of the grid or mesh will generally be of a size to prevent escape of the animal from the cage, although smaller sizes may be used to prevent the exchange of material, such as bedding, into and/or out of the cage.

It will also be appreciated that a similar result of preventing the exchange of material into and/or out of the recipient cage may be accomplished without the use of a grid or mesh, by utilising an inlet composed of multiple small openings.

Each of the cages housing a recipient animal may further include an outlet to allow air to flow out of the cage. The outlet may be a single aperture in the wall of the cage, or alternatively, the outlet may be composed of multiple openings in the wall of the cage. This outlet is typically necessary when the host cage is placed under positive pressure with respect to the recipient cages. Thus, in this fashion air is drawn through the host cage into each of the recipient cages.

The connection of the plurality of cages housing a recipient animal to the cage housing a host animal allows air to flow via the outlet of the host cage into each recipient cage via an inlet.

In one embodiment, each recipient cage is docked with the host cage directly, thus making a direct connection between the cages.

In an alternative embodiment, the plurality of recipient cages may be indirectly connected to the host cage, for example by way of a spacer pipe for each recipient cage.

In another embodiment, a portion of either the host cage or the contact cage is physically received into the other cage to produce a connection between the cages.

In one embodiment, the cage housing a host animal and each of the cages housing a recipient animal include a compatible coupling arrangement to directly connect the cages together. This compatible coupling arrangement allows the docking of the host cage and the recipient cage together.

In one embodiment, the compatible coupling arrangement surrounds an outlet on the host cage and surrounds the inlet on the recipient cage.

In an alternative embodiment, the compatible coupling arrangement is located adjacent to the outlet and inlet on the host and recipient cage (respectively), and thus brings the inlet and outlet into direct contact to allow air flow from the host cage into the recipient cage without being located between the inlet and the outlet.

As described previously herein, in the case of indirect connection of the cages together, a spacer pipe may be used for example, each end of the spacer pipe having a coupling arrangement compatible for the cage to which it is to be docked.

In one embodiment, the coupling arrangement for direct or indirect connection provides a substantially air tight seal between the host cage and the recipient cage.

Examples of compatible coupling arrangements are known in the art and include a mechanical clamp, magnetic clamps, or a male/female sleeve and O-ring arrangement, such as a male/female interference fit.

In one embodiment, the host cage includes the female component of a male/female sleeve and O-ring arrangement, and the recipient cage includes the male component and O-ring. Thus, a recipient cage is received directly into the host cage to allow air to flow between the cages.

In one embodiment, the cage housing the host animal includes a closure for each of the outlets to prevent air flow from the cage via an outlet under circumstances when air flow out of the cage is not desired.

In one embodiment, each of the cages housing a recipient animal includes a closure to prevent air flow into the cage via an inlet under circumstances when air flow into the cage is not desired.

In another embodiment, either or both of the host cage and the contact cage have a closure that is open upon receiving the end of one cage into the other cage.

In another embodiment, each compatible coupling arrangement includes a closure that prevents air flow out of the cage housing the host animal via an outlet under circumstances when air flow from the host cage is not desired.

The closure may be, for example, manually, mechanically or electrically operated, and be located vertically or horizontally with respect to the cages.

In another embodiment, each compatible coupling arrangement includes a closure that prevents air flow into a cage housing a recipient animal via the inlet under circumstances when air flow into the cage is not desired.

In one embodiment, the compatible coupling arrangement includes a closure on the host side and a closure on the recipient cage side. In one specific embodiment, the closures are linked to each other so that the closures may be opened or closed together. For example, a single handle attached to both closures can be used to simultaneously open and close the closures.

The cage housing the recipient animal may further include a filter for each of the inlets, each filter filtering air flowing into the cage via an inlet. In one embodiment, the filter allows air to flow into the cage but prevents infectious agents to escape from the cage.

The primary inlet on the host cage may also include a filter.

In one embodiment, the host cage and the recipient cages are not maintained under negative or positive pressure. In this embodiment, transfer of an infectious agent in one or more of the test animals to a recipient animal occurs under conditions where air is able to circulate from the host cage to the recipient cage.

The present invention also provides an animal housing cage that allows docking to multiple contact cages.

Accordingly, in another embodiment the present invention also provides an animal housing cage, the cage including a plurality of openings to allow air to flow into and/or out of the cage from each of the openings, and a plurality of connectors, each connector allowing direct or indirect connection of the animal housing cage to a second animal housing cage and (i) permitting air to flow into the second animal housing cage via an opening on the second animal housing cage from the animal housing cage via one of the plurality of openings and/or (ii) permitting air to flow out of the second animal housing cage via an opening on the second animal into the animal housing cage via one of the plurality of openings on the animal housing cage.

Details of the animal housing cage are generally as discussed previously herein in regard to the sentinel cage in the first embodiment of the present invention.

In one embodiment, the plurality of openings allow air to flow into the cage, and each connector permits allows air to flow out of the second animal housing cage into the animal housing cage via an outlet on the second animal housing cage.

Accordingly, in another embodiment the present invention provides an animal housing cage, the cage including a plurality of inlets to allow air to flow into the cage from each of the inlets and a plurality of connectors, each connector allowing direct or indirect connection of the animal housing cage to a second animal housing cage and permitting air to flow from the second animal housing cage via an outlet on the second animal housing cage into the animal housing cage via one of the plurality of inlets.

The animal housing cage may further include a filter for each of the openings, each filter filtering air flowing into the cage via an opening.

In one embodiment, the filter allows air to flow into the cage but prevents infectious agents to escape from the cage.

In another embodiment, the plurality of openings on the cage allow air to flow from the cage, and each connector allows air to flow into another animal housing cage from the animal housing cage via an inlet on the second animal housing cage.

Accordingly, in another embodiment the present invention also provides an animal housing cage, the cage including a plurality of outlets to allow air to flow from the cage from each of the outlets and a plurality of connectors, each connector allowing direct or indirect connection of the animal housing cage to a second animal housing cage and permitting air to flow into the second animal housing cage via an inlet on the second animal housing cage from the animal housing cage via one of the plurality of outlets.

In one embodiment, the cage includes a filter for each of the openings, each filter filtering air flowing into and/or from the cage via an opening. In one specific embodiment, the filter allows air to flow from the cage but prevents infectious agents to enter the cage.

In one embodiment, the connector is part of a compatible coupling arrangement to connect the animal housing cage to a second animal housing cage.

In another embodiment, the cage includes a closure for each of the openings that prevents air flowing into and/or out of the cage via the opening under circumstances when air flow into and/or out of the cage is not desired.

In one embodiment, the connector includes a closure that is used to prevent air flowing into and/out of the cage via an opening under circumstances when air flow into and/or out of the cage is not desired.

Details of various closures are as previously discussed herein.

The present invention also provides an animal housing cage that allows a portion of another cage to be received into the cage and a substantially air tight seal made when that occurs.

Accordingly, the present invention also provides an animal housing cage, the animal housing cage including a plurality of openings, each opening permitting a portion of a second animal housing cage to be received into the animal housing cage, wherein a substantially air tight seal is made between the animal housing cage and the second animal housing cage when the portion of the second animal housing cage is received into the animal housing cage.

The present invention also provides an assembly of the various cages described herein.

Accordingly, in another embodiment the present invention provides an assembly of cages, the assembly including an animal housing cage including a plurality openings to allow air to flow into the animal housing cage from each of the openings and/or to allow air to flow from the animal housing cage from each of the openings, and a plurality of second animal housing cages, each second animal housing cage connected directly or indirectly to the animal housing cage, the connection between the animal housing cage and the second animal housing cage permitting air to flow from the second animal housing cage into the animal housing cage via an opening and/or permitting air to flow from the animal housing cage into the second animal housing cage via an opening.

For example, in one embodiment there is provided an assembly of cages described with reference to the sentinel and one or more contact cages.

Therefore, in one specific embodiment there is provided an assembly of cages, the assembly including an animal housing cage including a plurality of inlets to allow air to flow into the animal housing cage from each of the inlets, and a plurality of second animal housing cages, each second animal housing cage connected directly or indirectly to the animal housing cage, the connection between the animal housing cage and the second animal housing cage permitting air to flow from the second animal housing cage into the animal housing cage via an inlet.

In another embodiment there is provided an assembly of cages described with reference to the host cage housing an infected animal and a contact cage housing a recipient animal.

Therefore, in another embodiment there is provided an assembly of cages, the assembly including an animal housing cage including a plurality of outlets to allow air to flow from the animal housing cage from each of the outlets, and a plurality of second animal housing cages, each second animal housing cage connected directly or indirectly to the animal housing cage, the connection between the animal housing cage and the second animal housing cage permitting air to flow from the animal housing cage into the animal housing cage via an outlet.

The present invention also provides a sentinel cage previously described herein in which the contact cages are physically received into the sentinel cage to establish a connection between the cages.

Accordingly, in another embodiment the present invention provides an animal housing cage including a plurality of openings, one or more of the plurality of opening able to receive an end of a second animal housing cage.

### DETAILED DESCRIPTION OF SPECIFIC EMBODIMENTS

To illustrate embodiments of the present invention, the following discussion refers to a method of determining the presence of an infectious agent in one or more test animals, and embodiments of cages, and assembly of cages, for testing the presence of an infectious agent.

### Example 1

### Method and Cages for Determining the Presence of an Infectious Agent in One or More Test Animals

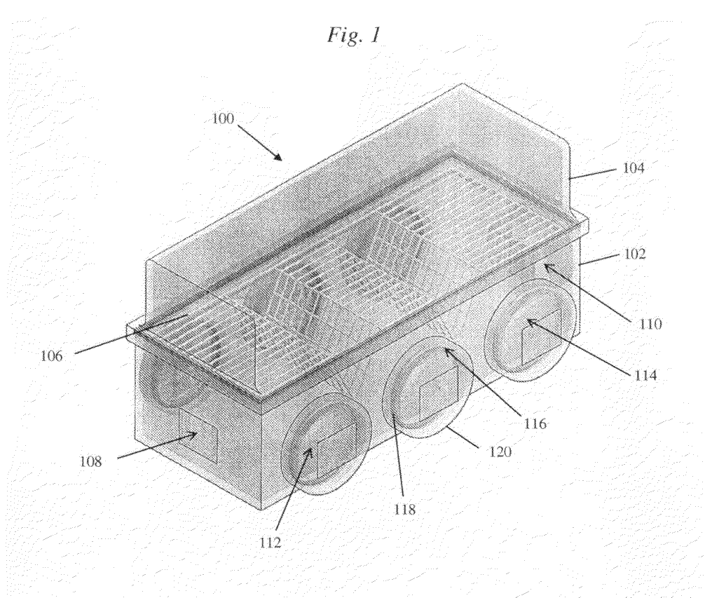

FIG. 1 is an illustration of a cage 100 for housing a sentinel animal in one embodiment of the present invention.

The sentinel cage 100 houses one or more animals for detecting the presence of infectious agents.

In the embodiment shown, the sentinel cage has a base 102 attached to a lid 104. The lid 104 of the sentinel cage 100 forms a contact seal (eg neoprene or rubber) with the base 102 to ensure individual bio-containment to prevent the spread of infectious particles. However, it will also be appreciated that the sentinel cage may not have a base and lid.

In the embodiment shown, located within the sentinel cage 100 is a stainless steel wire support 106 that sits above the animal, and which supports an independent feed and water supply (not shown).

The cage 100 may be constructed from a suitable material, such as polycarbonate or polysulphone plastic.

In the embodiment shown, the sentinel cage 100 may also include a primary air inlet 108 and an exhaust outlet 110.

The exhaust outlet 110 is connected to a negative pressure plenum (not shown) exhausting air either back into the room if fan forced through a HEPA filter, or directly into the room exhaust system if a passive exhaust/air exchange system is in operation. The primary air inlet 108 may also include a filter to filter air entering the cage, and a cap or other arrangement that covers the air inlet to prevent air flowing into the cage under conditions where air flow into the sentinel cage is not desired.

The sentinel cage 100 includes multiple openings 112 along either or both of the two long sides of the base 102 of the cage 100 to allow air to flow into the cage through each of the openings 112.

Stainless steel grids or wires 114 may also be incorporated in, or attached to the wall, of the base 102 of the cage 100 cover each opening 112 to allow free passage of air, aerosols produced by the animals contained within the contact cage, and small sized particulate matter (eg dust and dander). The grid or wire is sized to prevent animal escape.

In the embodiment shown, encompassing each opening 112 is the female component 116 of a male/female sleeve and O-ring coupling arrangement which allows a contact cage to dock with the sentinel cage 100. The arrangement of multiple openings 112 spaced along each side allows simultaneous docking of multiple contact cages (not shown) housing one or more test animals with the sentinel cage 100, each coupling arrangement 116 docking with a contact cage to allow air to flow from the contact cage into the sentinel cage 100 through an opening 112.

In the embodiment shown, the coupling arrangement surrounds the opening 112 and produces a substantially air tight seal between the sentinel cage 100 and the contact cage by the male/female sleeve and O-ring arrangement. The female sleeve component 116 of the coupling arrangement receives a compatible male component of the coupling arrangement on the contact cage. The male component of the coupling arrangement (not shown) on the contact cage has an O-ring which contacts the inside of the female component 116 to produce an air tight seal.

However, it will also be appreciated that other forms of coupling arrangement may be utilized, and that the coupling arrangement may not necessarily form an air tight seal between the sentinel cage 100 and the contact cage 200.

In the embodiment shown, air flow through an opening 112 may be prevented when the sentinel cage is not docked to a contact cage by a cap 120 that fits over the female sleeve component 116 of the coupling arrangement and contacts an O-ring 118 on the outer surface of the female sleeve 116. The cap 120 provides the female component of a male/female sleeve and O-ring arrangement, making an air tight seal by contacting the O-ring 118 with the cap 120.

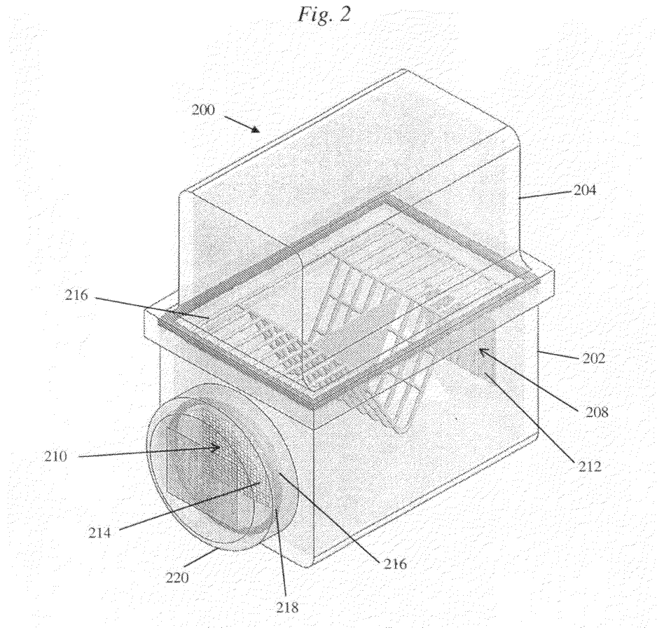

FIG. 2 illustrates a contact cage for housing one or more test animals and which may be docked with the sentinel cage in one embodiment of the present invention.

A contact cage 200 houses one or more test animals of unknown microbiological health status.

In the embodiment shown, the contact cage 200 has a base 202 and a lid 204. The lid 204 of the contact cage 200 forms a contact seal (eg neoprene or rubber) with the base 202 to ensure individual bio-containment to prevent the spread of infectious particles. However, it will also be appreciated that the contact cage 200 may not have a base and lid.

The contact cage 200 may be constructed from a suitable material, such as polycarbonate or polysulphone plastic.

In the embodiment shown, located within the contact cage 200 is a stainless steel wire support 206 that sits above the one or more animals, and which supports an independent feed and water supply (not shown).

The contact cage 200 includes an air outlet 210. The contact cage may further include an air inlet 208, as shown in the illustrated embodiment.

A filter 212 may be incorporated in, or attached to the inner or outer side of wall, of the cage 200 and covering the air inlet 208 allow free passage of air into the contact cage via the air inlet but prevents escape of infectious agents.

Stainless steel grids or wires 214 may be incorporated in, or attached to the wall, of the cage 200 and covering the air outlet 210 allow free passage of air from the contact cage through the air outlet 210, and also allow passage of aerosols produced by the animals contained within the contact cage, and small sized particulate matter (eg dust and dander) through the outlet. The grid or wires 214 are sized to prevent animal escape.

In the embodiment shown, encompassing each air outlet 210 is the male component 216 of a male/female sleeve and O-ring coupling arrangement which allows docking of the contact cage 200 with the sentinel cage, and thereby permitting air to flow from the contact cage 200 via the outlet 210 into the sentinel cage.

The coupling arrangement produces a substantially air tight seal between the contact cage 200 and the sentinel cage by the male/female sleeve and O-ring arrangement. The male component 216 of the coupling arrangement is received into the compatible female component of the coupling arrangement on the sentinel cage. The male component has an O-ring 218 which contacts the inner wall of the female component on the sentinel to produce an air tight seal.

However, it will also be appreciated that other forms of coupling arrangement may be utilized, and that the coupling arrangement may not necessarily form an air tight seal between the sentinel cage 100 and the contact cage 200.

Air flow from the outlet 210 may be prevented when the contact cage is not docked to a sentinel cage by a cap 220 that encompasses the male component 216 of the coupling arrangement. The cap 220 provides the female component of a male/female sleeve and O-ring arrangement, making an air tight seal by contacting the O-ring 218 with the cap 220.

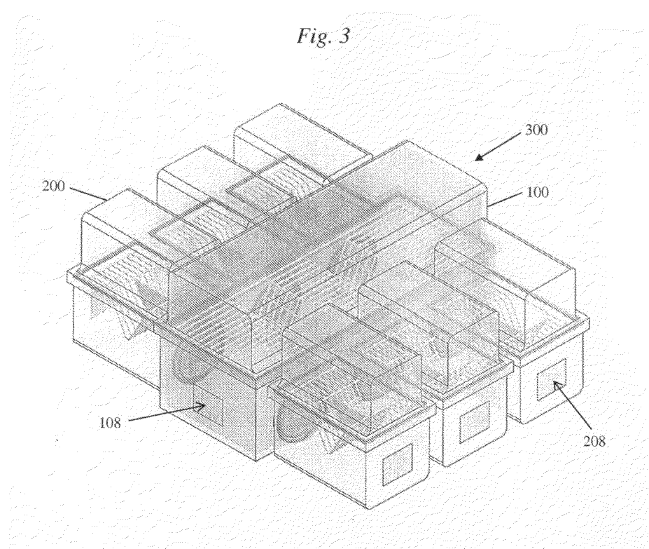

FIG. 3 illustrates an assembly of a sentinel cage coupled to multiple contact cages in one embodiment of the present invention.

An assembly 300 of a sentinel cage 100 is docked with multiple contact cages 200. In the situation when the assembly is placed under negative pressure, the rear of the sentinel cage 100 may be attached to a negative pressure plenum at the exhaust outlet (not visible), thus drawing air in through the primary air inlet 108 of the sentinel cage and through each of the contact cages via the inlets 208.

In the illustrated embodiment, to construct the assembly of sentinel cage 100 and the multiple contact cages 200, the cages are joined together by removing the caps on the inlets of the sentinel cage and removing the cap on each contact cage and pushing the male circular sleeve on the contact cage into the female sleeve on the sentinel cage.

The whole assembly 300 may be mounted on a rack system, so that 6 to 8 of the assemblies can be stacked vertically. The sentinel cage 100 may slot in first using guide rails, with contact cages 200 slotting in at 90 degrees again with guide rails

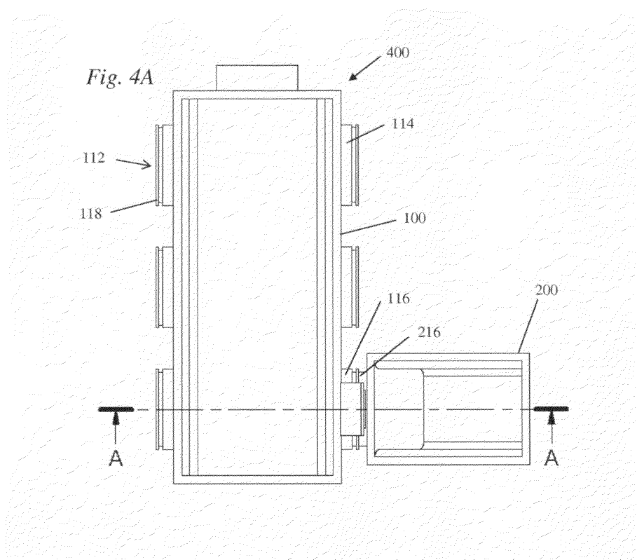

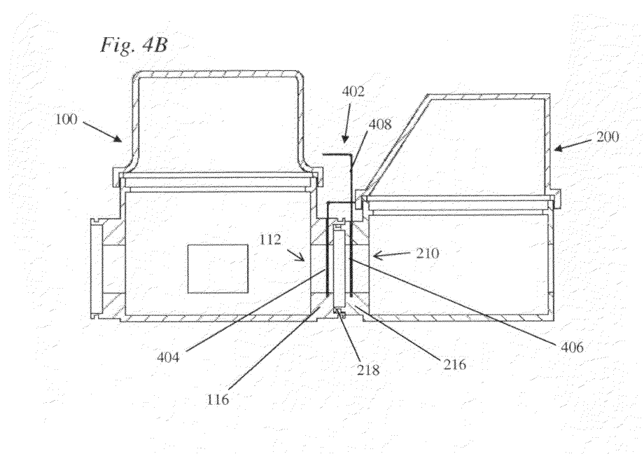

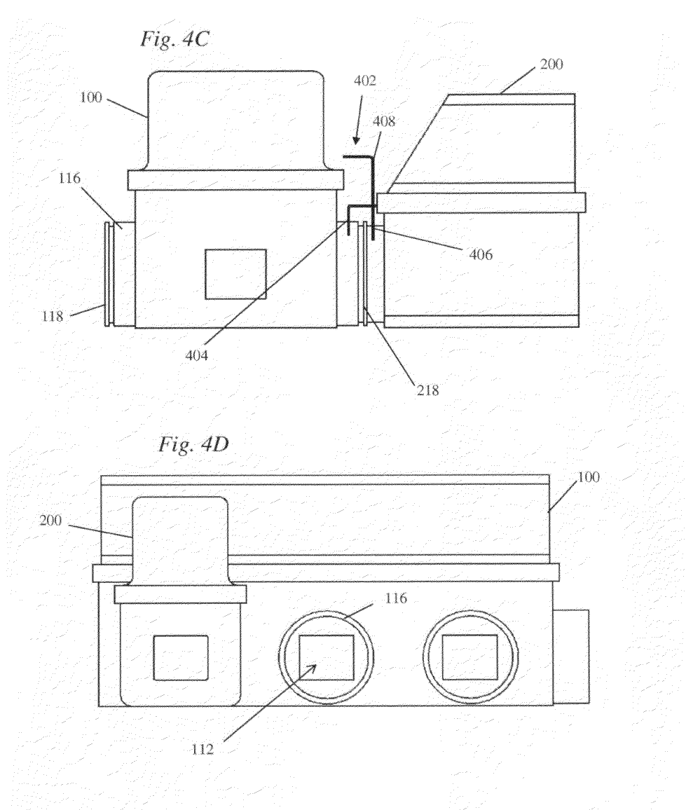

FIG. 4 illustrates a sentinel cage docked with a contact cage. FIG. 4A shows a view of the assembly from above. FIG. 4B shows a cross-sectional view taken at A-A. FIG. 4C shows the assembly viewed from the primary inlet end of the sentinel cage, and FIG. 4D shows the assembly viewed from a side of the sentinel cage.

In the embodiment shown, the assembly 400 of a sentinel cage 100 and a contact cage 200 are connected to allow air flow from the contact cage 200 into the sentinel cage 100 via the male 216 and female 116 sleeve and O-ring arrangement. A cap may be placed over each inlet 112 by contacting with the O-ring 118 to produce an air-tight seal to prevent air flowing into the sentinel cage 100 through the inlet 112.

Referring to FIG. 4B, the male component 216 of the coupling arrangement is received into the female component 116 by a sleeve and O-ring arrangement. The O-ring 218 on the outside of the male component makes an air tight seal when engaged with the inner surface of the female component of the coupling arrangement.

The coupling arrangement may also have a gate system 402 to control air flow through the system. In the illustrated embodiment, the gate system 402 is a vertical sluice gate system, having a first gate 404 to control air flow at the sentinel cage 100 side of the assembly, and a second gate 406 to control air flow at the contact cage 200 side of the assembly. In the illustrated embodiment, the sluice gates 402 and 404 are simultaneously controlled by a handle 408 connected to both the sluice gate 404 and 406.

FIG. 4B shows the sluice gate system in the closed position. In this position, the gates cover the entire inlet of the sentinel cage and the outlet of the contact cage, thus preventing air flow through each of the openings.

In the open position, the sluice gates 402 and 404 are raised, which allows air to flow from the outlet 210 of the contact cage via the inlet 112 of the sentinel cage.

Referring to FIG. 4C, in the illustrated embodiment the female sleeve 116 component has an O-ring 118 located on the outside of the sleeve for engaging with a cap to seal each particular inlet into the sentinel cage 100.

The sluice gates 404 and 406 may have an incorporated filter so that when the gates are in the closed position, air may flow into the sentinel or contact cage through the filter but prevent infectious particle escape. The gates 404 and 406 may further incorporate a mechanism which locks them in the open position when the cages are in use.

Referring to FIG. 4D, the sentinel cage 100 is shown docked with a contact cage 200 in one embodiment of the present invention. Two further free air inlets 112 along the side of the sentinel cage 100 are shown, with a female sleeve 116 encompassing each air inlet 112.

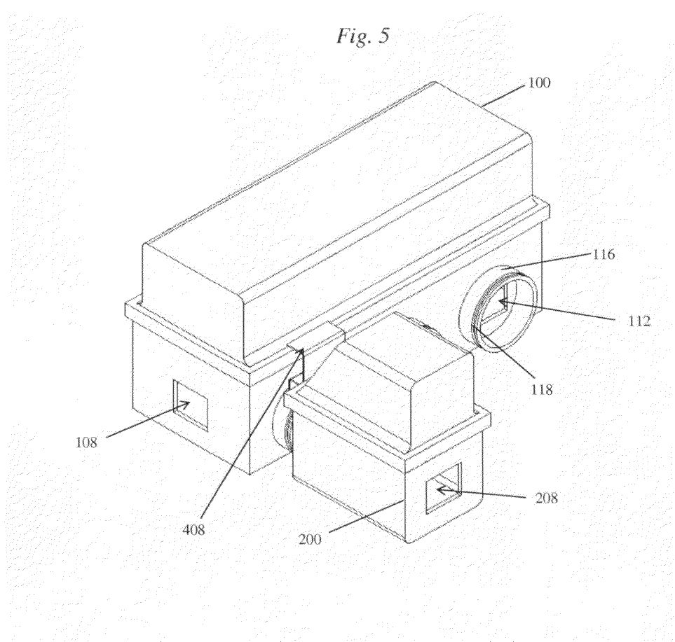

FIG. 5 shows a perspective view of a sentinel cage 100 docked with a contact cage 200 in one embodiment of the present invention. The sentinel cage may have a primary air inlet 108. The sluice gates (not visible) are operated by a handle 408. This Figure also shows the air inlet 208 for the contact cage, an air inlet 112 on the sentinel cage, the female sleeve component 116 of the coupling arrangement on the sentinel cage encompassing an air inlet 112, and the O-ring 118 for engaging with a cap to seal the air inlet.

In operation, one or more sentinel animals known to be free of infection are introduced into the sentinel cage. The sentinel animals will generally be a mix of immunocompetent animals capable of measurable antibody production and immunocompromised animals. For rodents, suitable ages are approximately 5-6 weeks on introduction into the sentinel cage.

The sentinel cage is attached to a plenum at the exhaust outlet, with all the sluice gates in closed position or sealing caps attached.

A weanling animal or animals from litters to be monitored are introduced into the contact cages with all gates in the closed position or sealing caps attached.

One or more contact cages are docked with the sentinel cage by removing the sealing caps and pushing the sleeves together or by pushing the sleeves together and moving the gates on both the contact and sentinel cage couplings to the open position.

“Quasi” contact is then maintained for a suitable period of time to allow infection of the sentinel animal(s). If the sentinel cage is under negative pressure, this will in particular facilitate transfer of air from the contact cage (drawn in through the inlet on the contact cage) to the sentinel cage.

Contact animals can be removed by removing the contact cage and fitting the sealing caps to both the contact cage and sentinel cage sleeves, or by moving the sluice gates on the sentinel and contact cage couplings to the closed position and uncoupling the contact cage. If desired a new contact cage containing new contact animals can be docked with the sentinel cage.

Three weeks after the last contact cage of monitoring round (usually quarterly) or batch (if monitoring a particular experiment or strain) has been added, all contact cages removed as described above. The sentinels are then sent for pathology/serology/bacteriology/parasitology examination.

This methodology described above can also be modified or enhanced by use of soiled bedding introduction from the population being monitored to the sentinel cage

Removal of the air filter inlet in the sentinel cage and replacement by a wire grid can also be used to monitor environmental air contamination.

The following discussion refers to a method of determining the susceptibility of one or more recipient animals to infection by an infectious agent.

Alternatively, the system described may be generally reversed to determine the susceptibility of one or more recipient animals to infection by an infectious agent. For example, the method may be used to determine the susceptibility of animals of a particular type (eg genotype or phenotype) to infection.

In this embodiment, one or more recipient animals known or suspected to be free of infection are introduced into each contact cage with all gates in the closed position or sealing caps attached. For rodents, suitable ages are approximately 5-6 weeks on introduction into the contact cage.

One or more sentinel animals known to be infected with a particular infectious agent are introduced into the sentinel cage, with all the sluice gates in closed position or sealing caps attached. For rodents, suitable ages are approximately 5-6 weeks on introduction into the sentinel cage.

One or more contact cages are docked with the sentinel cage by removing the sealing caps and pushing the sleeves together or by pushing the sleeves together and moving the gates on both the contact and sentinel cage couplings to the open position.

Air under positive pressure is introduced into the sentinel cage via the primary air inlet, and air allowed to flow from the sentinel cage into the contact cages and exhausting from the rear of the contact cages.

“Quasi” contact is then maintained for a suitable period of time to allow infection of the recipient animal(s).

Contact animals can be removed by removing the contact cage and fitting the sealing caps to both the contact cage and sentinel cage sleeves, or by moving the sluice gates on the sentinel and contact cage couplings to the closed position and uncoupling the contact cage. If desired a new contact cage containing new animals can be docked with the sentinel cage.

Three weeks after their last contact, recipient animals are then sent for pathology/serology/bacteriology/parasitology examination. In this way, the susceptibility of animal to infection may be determined.

### Example 2

### Proof of Concept Study

The purpose of this study was to determine if an infectious agent (Sendai virus) primarily spread by aerosol from infected animals could be detected by using a prototype cage system utilising the sentinel cage system described herein.

Sendai virus, also known as murine parainfluenza virus type 1, is a negative sense, single-stranded RNA virus of the Paramyxoviridae family. The virus is a member of the paramyxovirus subfamily Paramyxovirinae, genus Respirovirus, members of which primarily infect mammals.

Sendai virus is responsible for a highly transmissible respiratory tract infection in mice and other laboratory animals such as hamsters, guinea pigs, and rats, and occasionally pigs, with infection passing through both air and by direct contact routes. The virus is present in mouse colonies worldwide, and infections occur in suckling to young adult mice.

### (i) Materials and Methods

Cage and rack system: Modifications were carried out on a commercially available cage and rack system (M8501051 14 Cage Rack Assembly) purchased from Australian Animal Care Systems (AACS). This assembly provides 7 tiers (designated R1 to R7) for the provision of cages.

Modifications to the rack assembly involved removal of side support struts (both sides) and the addition of support trays for test cages, and the addition of fan forced exhaust extraction unit, damper system and in-line HEPA filtration unit to rear plenum.

The sentinel cage was custom constructed with docking ports (×4) for each sentinel cage. This involved precision cutting through the sides of the sentinel cage, fabrication and fixing of docking collar, involving a male-female interference fit system.

Construction and fixing of Blanking plates were constructed and fixed to air inlets at the front of the sentinel cages. Standard filters were retained on the air inlets of the test cages and the exhaust outlets of the sentinel cages. Filters were removed from the exhaust outlets of the tests cages and replaced with 2 mm wire mesh. Outlets were coupled to the docking collar using standard fittings.

Air Changes per Hour (ACH): Air changes per hour were calculated by measuring the airflow inside the sentinel cage at the inlets from the test cages and averaging the results. It was observed that there was a gradient in the prototype system from R1 (bottom tier—17 ACH in test cage: 30 ACH in sentinel cage) to R7 (top tier—70 ACH in test cage: 110 ACH in sentinel cage).

In order to minimise the dilution effect, it was decided to only use the bottom three tiers of the system (Maximum ACH test cage 40: Maximum ACH in sentinel cage 70), R1 to R3.

Although the prototype system described herein provides a gradient in ACH values, other embodiments provide even air changes per hour in each tier.

Mice: 30× female Swiss ARC(s) and 3× female NOD SCID mice aged 7 wks were sourced from a commercial supplier (Animal Resources Centre, Perth). All mice were sourced from barrier unit 1, and were free of antibody directed against Sendai virus.

Virus: Sendai virus was obtained from the American Type Culture Collection (ATCC) Cat No VR-105. Virus was supplied as 1.0 mL allantoic fluid, 10^{8.25}CEID₅₀/0.2 mL.

Virus was passaged in BHK21 cells. Innocula was prepared by freeze thawing of cell culture showing >70% CPE after 5 days, clarification by centrifugation and concentration by cross membrane dialysis. Final TCID₅₀ of stock solution was shown to be 15 TCID₅₀/0.1 mL

Serology: Two different ELISA systems were utilized—Biotech Trading Partners (serum dilution 1:50) and an in-house system using antigen sourced from BioReliance (serum dilution 1:100) according to manufacturer's or in-house protocols.

All sera on day 21 were also tested by IFA using Charles River laboratories slides (serum dilution 1:20) according to supplier protocols.

RT-PCR: RT-PCR to detect virus was performed according to the method of Wagner et al. (2003) Comp. Med Vol 53, p 173-177, herein incorporated by reference.

### (ii) Design of Study

Three experimental groups of animals were set up in the bottom three tiers of the rack system (R1, R2 and R3) according to Figure X. Arrows show direction of airflow through the system.

Cage T1 and T4: 1× Swiss mouse infected intranasally with 20 (R1—bottom tier), 200 (R2—middle tier) or 300 (R3—top tier) TCID₅₀ Sendai virus in media. 1× Swiss mouse mock infected with 20 uL PBS.

Cage T3 and T2: 2× Swiss mouse uninfected

Sentinel Cage: 2× Swiss mouse and 1×SCID mouse, uninfected

Mice were monitored daily for clinical signs of infection.

Test bleeds were taken from all mice in cages T1, T4 and sentinel cages on Day 14 for the determination of Antibody (IgG) levels to Sendai virus.

All mice sacrificed on Day 21 and serum, lung tissue and spleen taken for analysis

(iii) Results
1. No mice showed any clinical signs of infection throughout the course of the study
2. All mice bled prior to study (Day 0) and tested for antibody to Sendai virus. All tested negative (data not shown).

The results are shown in Table 1.

TABLE 1

| | | Serology | | | | | | RT-PCR | |
|---|---|---|---|---|---|---|---|---|---|
| | | BTP | | In-House | | IFA | | Lung | Spleen |
| Mouse ID | Dose (TCID₅₀) | D 14 | D 21 | D 14 | D 21 | D 14 | D 21 | D 21 | D 21 |
| R1T1 Swiss 1 | 20 | Pos | Pos | Pos | Pos | Pos | Pos | Pos | Pos |
| R1T1 Swiss 2 | PBS | Pos | Pos | Pos | Pos | Pos | Pos | Pos | Pos |
| R1T2 Swiss 1 | — | NT | Neg | NT | Neg | NT | Neg | Pos | Neg |
| R1T2 Swiss 2 | — | NT | Neg | NT | Neg | NT | Neg | Pos | Neg |
| R1T3 Swiss 1 | — | NT | Neg | NT | Neg | NT | Neg | Pos | Neg |
| R1T3 Swiss 2 | — | NT | Neg | NT | Neg | NT | Neg | Pos | Pos |
| R1T4 Swiss 1 | 20 | Pos | Pos | Pos | Pos | Pos | Pos | Pos | Pos |
| R1T4 Swiss 2 | PBS | Pos | Pos | Pos | Pos | Pos | Pos | Pos | Pos |
| R1Sent Swiss 1 | Sentinel | Pos | Pos | Pos | Pos | Pos | Pos | Pos | Pos |
| R1Sent Swiss 2 | Sentinel | Neg | Neg | Neg | Neg | Neg | Neg | Pos | Pos |
| R1Sent SCID | Sentinel | Neg | Neg | Neg | Neg | Neg | Neg | Pos | Pos |
| R2T1 Swiss 1 | 200 | Pos | Pos | Pos | Pos | Pos | Pos | Pos | Pos |
| R2T1 Swiss 2 | PBS | Pos | Pos | Pos | Pos | Pos | Pos | Pos | Pos |
| R2T2 Swiss 1 | — | NT | Neg | NT | Neg | NT | Neg | Pos | Neg |
| R2T2 Swiss 2 | — | NT | Neg | NT | Neg | NT | Neg | Pos | Pos |
| R2T3 Swiss 1 | — | NT | Neg | NT | Neg | NT | Neg | Neg | Neg |
| R2T3 Swiss 2 | — | NT | Neg | NT | Neg | NT | Neg | Pos | Pos |
| R2T4 Swiss 1 | 200 | Pos | Pos | Pos | Pos | Pos | Pos | Pos | Pos |
| R2T4 Swiss 2 | PBS | Pos | Pos | Pos | Pos | Pos | Pos | Pos | Pos |
| R2Sent Swiss 1 | Sentinel | Pos | Pos | Pos | Pos | Pos | Pos | Pos | Pos |
| R2Sent Swiss 2 | Sentinel | Neg | Neg | Neg | Neg | Neg | Neg | Pos | Pos |
| R2Sent SCID | Sentinel | Neg | Neg | Neg | Neg | Neg | Neg | Pos | Pos |
| R3T1 Swiss 1 | 300 | Pos | Pos | Pos | Pos | Pos | Pos | Pos | Pos |
| R3T1 Swiss 2 | PBS | Pos | Pos | Pos | Pos | Pos | Pos | Pos | Neg |
| R3T2 Swiss 1 | — | NT | Neg | NT | Neg | NT | Neg | Neg | Neg |
| R3T2 Swiss 2 | — | NT | Neg | NT | Neg | NT | Neg | Neg | Neg |
| R3T3 Swiss 1 | — | NT | Neg | NT | Neg | NT | Neg | Neg | Neg |
| R3T3 Swiss 2 | — | NT | Neg | NT | Neg | NT | Neg | Neg | Neg |
| R3T4 Swiss 1 | 300 | Pos | Pos | Pos | Pos | Pos | Pos | Pos | Pos |
| R3T4 Swiss 2 | PBS | Pos | Pos | Pos | Pos | Pos | Pos | Pos | Pos |
| R3Sent Swiss 1 | Sentinel | Neg | Neg | Neg | Neg | Neg | Neg | Pos | Pos |
| R3Sent Swiss 2 | Sentinel | Neg | Neg | Neg | Neg | Neg | Neg | Pos | Pos |
| R3Sent SCID | Sentinel | Neg | Neg | Neg | Neg | Neg | Neg | Pos | Pos |

### (iv) Discussion

### Serology:

All infected mice in cages T1 and T4 in tiers R1 to R3 were found to be positive for Sendai virus by serology.

At least one of the sentinel mice in tiers R1 and R2 were found to be positive for Sendai virus by serology.

None of the mice in cages T2 and T3 were found to be positive for Sendai virus by serology.

### RT-PCR:

All infected mice in cages T1 and T4 were found to be positive for Sendai virus in both tissue samples examined by RT-PCR.

All sentinel mice were found to be positive for Sendai virus in both tissue samples examined by RT-PCR.

For the mice present in cages T2 and T3 of tiers R1 and R3, it was found that at least one of the mice was positive for Sendai virus in at least one of the tissues samples examined by RT-PCR. In tier R3, none of the mice tested positive for Sendai virus by RT-PCR in either of the two tissue samples examined.

The above results confirm the infection of sentinel mice by mice infected with Sendai virus in the system described. In some cases, uninfected mice in other test cages were also infected with Sendai virus.

### Example 3

### Alternative Embodiment for Determining the Presence of an Infectious Agent in One or More Test Animals

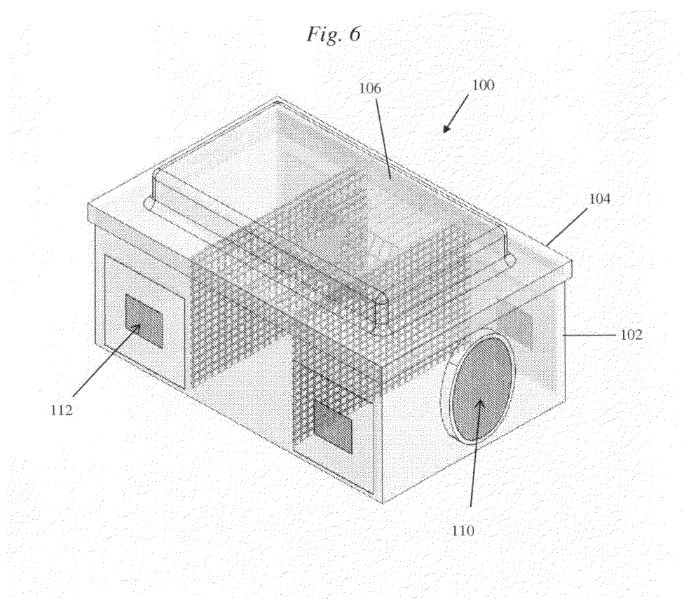

FIG. 6 is an illustration of a cage 100 for housing a sentinel animal in another embodiment of the present invention.

The sentinel cage 100 houses one or more animals for detecting the presence of infectious agents.

In the embodiment shown, the sentinel cage has a base 102 attached to a lid 104. The lid 104 of the sentinel cage 100 forms a contact seal (eg neoprene or rubber) with the base 102 to ensure individual bio-containment to prevent the spread of infectious particles. However, it will also be appreciated that the sentinel cage may not have a base and lid.

In the embodiment shown, located within the sentinel cage 100 is a stainless steel wire support 106 that sits above the animal, and which supports an independent feed and water supply (not shown).

The cage 100 may be constructed from a suitable material, such as polycarbonate or polysulphone plastic.

In the embodiment shown, the sentinel cage 100 may also include a primary air inlet (not shown) and an exhaust outlet 110.

The exhaust outlet 110 is connected to a negative pressure plenum (not shown) exhausting air either back into the room if fan forced through a HEPA filter, or directly into the room exhaust system if a passive exhaust/air exchange system is in operation. The primary air inlet may also include a filter to filter air entering the cage, and a cap or other arrangement that covers the air inlet to prevent air flowing into the cage under conditions where air flow into the sentinel cage is not desired.

The sentinel cage 100 includes multiple openings 112 along either or both of the two long sides of the base 102 of the cage 100 to allow air to flow into the cage through each of the openings 112.

Stainless steel grids or wires may also be incorporated in, or attached to the wall, of the base 102 of the cage 100 cover each opening 112 to allow free passage of air, aerosols produced by the animals contained within the contact cage, and small sized particulate matter (eg dust and dander). The grid or wire is sized to prevent animal escape.

In the embodiment shown, the arrangement of multiple openings 112 spaced along each side allows simultaneous connection of multiple contact cages (not shown) housing one or more test animals with the sentinel cage 100, so that when connected to a contact cage this allow airs to flow from the contact cage into the sentinel cage 100 through an opening 112.

In this illustration, it will be noted that a sleeve surrounding each of the openings 112 is not shown for the purposes of clarity.

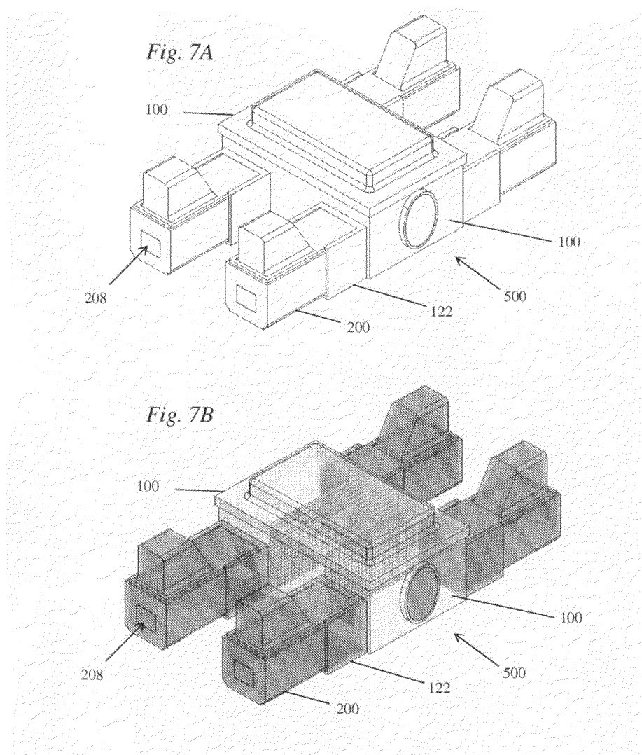

FIG. 7 illustrates an assembly 500 of a sentinel cage and multiple contact cages in an alternative embodiment of the present invention, in which a portion of each of the contact cages has yet to be inserted into the sentinel cage. Panel A shows a perspective view of the assembly, and panel B shows a transparent view of the assembly with selected internal components shown.

In this embodiment, the sentinel cage includes a sleeve 122 which allows a contact cage 200 to be placed into a suitable position so that a portion of the contact cage can be inserted into the sentinel cage 100. In the embodiment shown, the sleeve partially surrounds an opening in the sentinel cage. The sleeve 122 may be an integral part of the wall of the sentinel cage 100, or may be fixed to the sentinel cage 100.

Each contact cage 200 houses one or more test animals of unknown microbiological health status.

The contact cage 200 may be constructed from a suitable material, such as polycarbonate or polysulphone plastic.

In the embodiment shown, located within the contact cage 200 is a stainless steel wire support 206 that sits above the one or more animals, and which supports an independent feed and water supply (not shown).

The contact cage 200 includes an air outlet (now shown). The contact cage may further include an air inlet 208, as shown in the illustrated embodiment.

A filter may be incorporated in, or attached to the inner or outer side of wall, of the cage 200 and covering the air inlet 208 to allow free passage of air into the contact cage via the air inlet but prevents escape of infectious agents.

Stainless steel grids or wires may be incorporated in, or attached to the wall, of the cage 200 and covering the air outlet to allow free passage of air from the contact cage through the air outlet 210, and also allow passage of aerosols produced by the animals contained within the contact cage, and small sized particulate matter (eg dust and dander) through the outlet. The grid or wires may be sized to prevent animal escape.

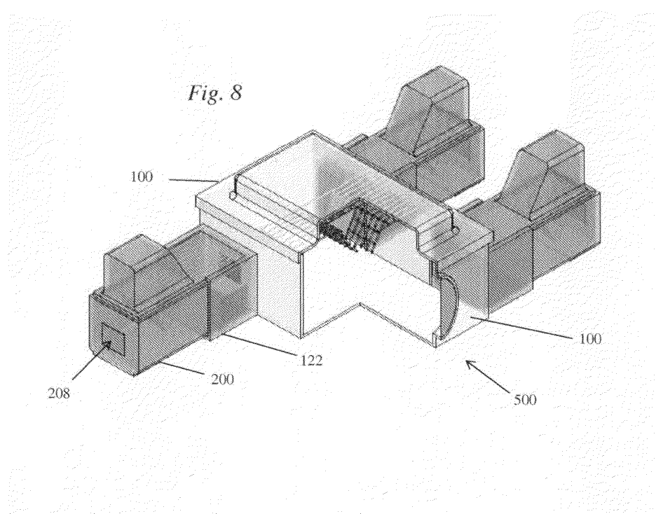

FIG. 8 shows a cut-away representation of FIG. 7B, in which it can be seen that a portion of the contact cage 200 has not been inserted into the sentinel cage.

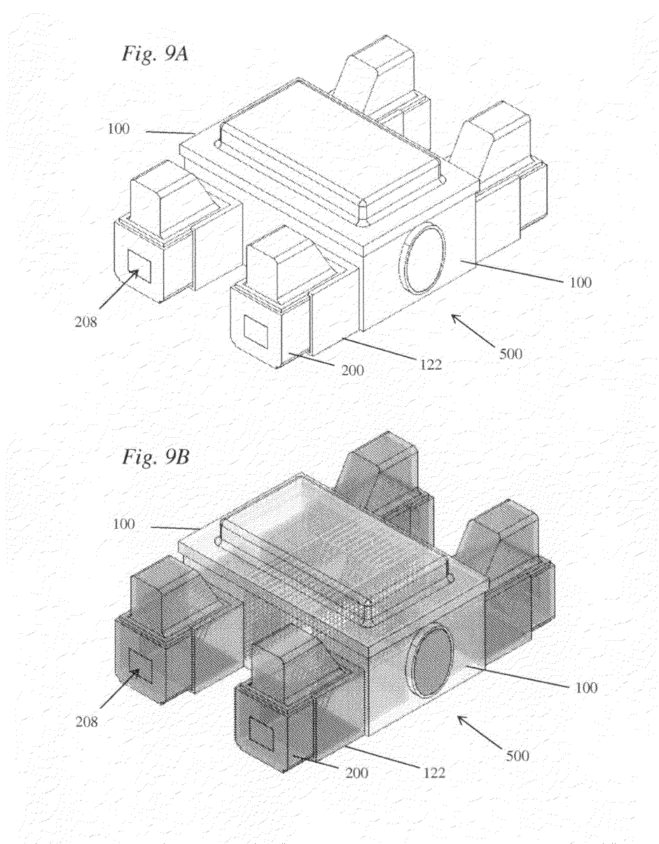

FIG. 9 illustrates an assembly of a sentinel cage and multiple contact cages in an alternative embodiment of the present invention, in which a portion of each of the contact cages has been inserted into the sentinel cage. Panel A shows a perspective view of the assembly, and panel B shows a transparent view of the assembly with selected internal components shown.

In this embodiment, the sentinel cage includes a sleeve 122 which has directed the insertion of the end of a contact cage 200 into the sentinel cage 100. It will be appreciated that the insertion of the contact cage into the sentinel cage may be achieved by a suitable method, such as manually inserting the contact cage into the sentinel cage, mechanical insertion or electrical insertion.

In this embodiment, the sleeve 122 may also make a substantially air tight seal with the contact cage 200, for example by use of material on the sleeve that engages with the outside of the contact cage.

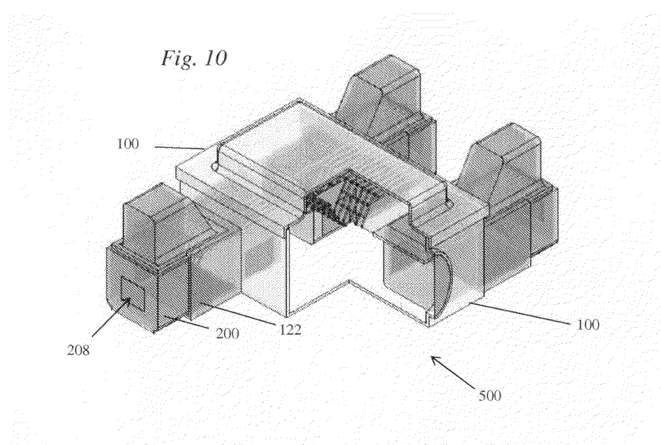

FIG. 10 shows a cut-away representation of FIG. 7B, in which it can be seen that a portion of the contact cage 200 has not been inserted into the sentinel cage.

Finally, it will be appreciated that various modifications and variations of the described methods and compositions of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are apparent to those skilled in the art are intended to be within the scope of the present invention.

1.-41. (canceled)

42. A method of determining the presence of an infectious agent in one or more test animals, the method including:
providing a cage housing a sentinel animal, the cage including a plurality of inlets to allow flow of air into the cage through each of the inlets;
providing a plurality of cages each housing a test animal, each cage including an outlet to allow air to flow from the cage;
connecting the plurality of cages each housing a test animal to the cage housing a sentinel animal so as to allow air to flow via the outlet of each cage housing a test animal into the cage housing a sentinel animal via an inlet on the cage housing a sentinel animal; and
screening the sentinel animal for infection by the infectious agent after a period of time sufficient for the sentinel animal to be infected from one of the test animals, wherein infection of the sentinel animal is indicative of the presence of the infectious agent in one or more of the test animals.

43. A method according to claim 42, wherein the connecting of a cage housing a test animal to the cage housing a sentinel animal is a direct connection of the cages.

44. A method according to claim 42, wherein the sentinel cage further includes a primary inlet to allow air to flow into the cage.

45. A method according to claim 42, wherein each of the cages housing a test animal includes an inlet to allow air to flow into the cage.

46. A method according to claim 42, wherein the cage housing a sentinel animal includes an outlet for allowing air to flow from the cage.

47. A method according to claim 46, wherein the cage housing a sentinel animal is under negative pressure applied at the outlet.

48. A method according to claim 42, wherein the cage housing the sentinel animal includes a closure for each of the inlets, each closure preventing air flow into the cage housing the sentinel animal via an inlet under circumstances when air flow into the cage is not desired.

49. A method according to claim 42, wherein each of the cages housing a test animal includes a closure that is used to prevent air flowing from the cage via the outlet under circumstances when air flow out of the cage is not desired.

50. A method according to claim 42, wherein the cage housing the sentinel animal includes a filter for each of the inlets, each filter filtering air flowing into the cage via an inlet.

51. A method according to claim 50, wherein the filter allows air to flow into the cage housing a sentinel animal but prevents infectious agents to escape from the cage.

52. A method according to claim 42, wherein the sentinel animal is an immunocompetent animal and/or an immunocompromised animal.

53. A method according to claim 42, wherein the screening of the sentinel animal includes measuring an immunological response in the sentinel animal.

54. An animal housing cage, the cage including a plurality of openings to allow air to flow into and/or out of the cage from each of the openings, and a plurality of connectors, each connector allowing direct or indirect connection of the animal housing cage to a second animal housing cage and (i) permitting air to flow into the second animal housing cage via an opening on the second animal housing cage from the animal housing cage via one of the plurality of openings and/or (ii) permitting air to flow out of the second animal housing cage via an opening on the second animal into the animal housing cage via one of the plurality of openings on the animal housing cage.

55. An animal housing cage according to claim 54, wherein the plurality of openings allow air to flow into the cage, and each connector allows air to flow out of the second animal housing cage into the animal housing cage via an opening on the second animal housing cage.

56. An animal housing cage according to claim 55, wherein the cage includes a filter for each of the openings, each filter filtering air flowing into the cage via an opening.

57. An animal housing according to claim 57, wherein the filter allows air to flow into the cage but prevents infectious agents to escape from the cage.

58. An animal housing cage according to claim 54, wherein the plurality of openings allow air to flow from the cage, and each connector permits air to flow into the second animal housing cage from the animal housing cage via an opening on the second animal housing cage.

59. An animal housing cage according to claim 58, wherein the cage includes a filter for each of the openings, each filter filtering air flowing from the cage via an opening

60. An animal housing according to claim 60, wherein the filter allows air to flow from the cage but prevents infectious agents to enter the cage.

61. An animal housing cage according to claim 54, wherein the cage includes a closure for each of the plurality of openings that prevents air flowing into and/or out of the cage via each opening under circumstances when air flow into and/or out of the cage is not desired.

62. An animal housing cage according to claim 54, wherein the plurality of openings is a plurality of inlets to allow air to flow into the cage from each of the inlets.

63. An animal housing cage according to claim 54, wherein the plurality of openings is a plurality of outlets to allow air to flow from the cage from each of the outlets.

64. An assembly of cages, the assembly including an animal housing cage including a plurality openings to allow air to flow into the animal housing cage from each of the openings and/or to allow air to flow from the animal housing cage from each of the openings, and a plurality of second animal housing cages, each second animal housing cage connected directly or indirectly to the animal housing cage, the connection between the animal housing cage and the second animal housing cage permitting air to flow from the second animal housing cage into the animal housing cage via an opening and/or permitting air to flow from the animal housing cage into the second animal housing cage via an opening.

65. An assembly of cages according to claim 64, wherein the plurality of openings is a plurality of inlets to allow air to flow into the animal housing cage from each of the inlets.

66. An assembly of cages according to claim 64, wherein the plurality of openings is a plurality of outlets to allow air to flow from the animal housing cage from each of the outlets.
